(19) United States
(12) Patent Application Publication
(10) Pub. No.: US 2007/0214932 A1
(43) Pub. Date: Sep. 20, 2007

(54) Individual string adjusting tailpiece

(76) Inventor: Tommy L. Stalans, Perry, FL (US)

Correspondence Address: Pennington, Moore, Wilkinson, Bell & Dunbar, P.A., P.O. Box 10095, Tallahassee, FL, 32302-2095, US

(21) Appl. No.: 11/384,878

(22) Filed: Mar. 20, 2006

(51) Int. Cl. G10D 3/12

(52) U.S. Cl. 84/300

(57) ABSTRACT

A tailpiece for a banjo with individual string adjustment control for independently adjusting the string angle of the banjo strings with respect to the bridge. The tailpiece includes a mounting bracket having a bearing plate and an attachment means for attaching the tailpiece to the banjo head. A separate lever arm is provided for attaching each of the banjo strings to the tailpiece and setting the string angle with respect to the bridge. Each lever arm has an a pin for attaching to the loop at the end of the banjo string, an angled bore to permit the banjo string to pass from the top surface of the lever arm to the bottom surface of the lever arm, and a groove at the end of the lever arm to prevent the string from sliding off of the lever arm. Each lever arm is attached to the mounting bracket by a pivot joint. Screws are provided on the lever arm to adjust the standoff of the lever arm with respect to the bearing plate, thereby adjusting the string angle with respect to the bridge. The turning screws are positioned on top of the tailpiece substantially perpendicularly to the banjo strings to facilitate “on the fly” string-angle tuning.

### BACKGROUND OF THE INVENTION

1. Field of the Invention

This invention relates to the field of banjos and other plectrum musical instruments of the banjo type. More specifically the present invention comprises a tailpiece for independently adjusting the approach angle of the individual strings of the instrument with respect to the bridge.

2. Description of the Related Art

Banjos are unique musical instruments which derive their sound from both the vibration of the banjo strings and banjo head. When a banjo player picks a string, the vibration of the banjo string is transmitted through a bridge to a skin stretched across the head of the banjo. This feature gives the banjo a percussive quality which is unique in the family of stringed instruments. This feature also makes the banjo a staple instrument in several musical genres including Bluegrass and American Old-Time.

There are many different ways that a banjo player may alter the sound or intonation of the banjo. For example, the player may change the type of skin, the treatment of the skin, the string tuning, the bridge, the string angle with respect to the bridge, or the tailpiece. The latter two can be related. The string angle with respect to the bridge is altered by the tailpiece. Many tailpieces are adjustable and allow the strings to be lowered toward the head to increase the angle, or raised from the head to decrease the angle. Conventional banjo tailpieces raise or lower the strings together in unison.

To perfect a banjo's sound it is often desirable to set the individual strings at different angles with respect to the bridge. This is difficult to accomplish with conventional tailpieces, typically requiring adjustments to be made at the bridge. This task can be so cumbersome that many banjo players elect to use the banjo without refining the string angle.

Some inventors have recognized the advantages of providing tailpieces that allow independent string adjustability. One example of such at tailpiece is described in U.S. Pat. No. 1,713,855 to Oettinger. These tailpieces have enjoyed only limited commercial success for several reasons. First, because the string-angle tuning screws are positioned on the tail of the banjo, it is difficult to tune “on the fly.” When using the Oettinger device, the banjo player adjusts the string angle with the screws then “picks” the string with a plectrum or a finger. If the intonation or sound is not ideal, the banjo player will increase or decrease the string angle, and then pick the string again. This procedure can be time consuming, requiring the player to adjust the position of the banjo to see and adjust the string-angle tuning screws and then reposition the banjo to pick the string.

Also, the Oettinger device can negatively influence the timbre of the instrument. One purpose of the tailpiece is to provide a fixed termination for the banjo strings. Oettinger's device vibrates slightly with the string. The vibration originates from two locations. First, the lever members vibrate laterally towards and away from the other lever members when the string is picked. Also, the “pinch” created at the pins of the Oettinger device can fail under heavy picking. This pinch failure can cause the termination point of the string move temporarily when the string is played. These vibrations can produce a “buzz” sound and can “muddy” the instrument's intonation.

It is therefore desirable to provide a tailpiece that can be used to adjust the string angle of the individual strings of the banjo while avoiding the problems associated with prior art tailpieces.

### BRIEF SUMMARY OF THE INVENTION

The present invention comprises a tailpiece for a banjo with individual string adjustment control for independently adjusting the string angle of the banjo strings with respect to the bridge. The tailpiece includes a mounting bracket having a bearing plate and an attachment means for attaching the tailpiece to the banjo head. A separate lever arm is provided for attaching each of the banjo strings to the tailpiece and setting the string angle with respect to the bridge. Each lever arm has an a pin for attaching to the loop at the end of the banjo string, an angled bore to permit the banjo string to pass from the top surface of the lever arm to the bottom surface of the lever arm, and a groove at the end of the lever arm to prevent the string from sliding off the lever arm. Each lever arm is attached to the mounting bracket by a pivot joint. Screws are provided on the lever arm to adjust the standoff of the lever arm with respect to the bearing plate, thereby adjusting the string angle with respect to the bridge. The turning screws are positioned on top of the tailpiece substantially perpendicularly to the banjo strings to facilitate “on the fly” string-angle tuning.

### DESCRIPTION OF THE SEVERAL VIEWS OF THE DRAWINGS

FIG. 1 is a perspective view, showing the present invention.

FIG. 2 is a perspective view, showing the present invention.

FIG. 3 is a side view, showing the present invention.

FIG. 4 is a perspective view, showing the present invention.

FIG. 5 is a perspective view, showing the present invention.

FIG. 6 is a section view, showing the present invention.

### REFERENCE NUMERALS IN THE DRAWINGS

| | | | |
|---|---|---|---|
| 10 | banjo head | 12 | tailpiece |
| 14 | bridge | 16 | skin |
| 18 | lever arms | 20 | anchor pins |
| 22 | screws | 24 | angled bore |
| 26 | support member | 28 | knurled head |
| 30 | groove | 32 | pivot bore |
| 34 | shorter standoff | 36 | bearing plate |
| 38 | taller standoff | 40 | pivot joint |
| 42 | attachment means | 44 | lever arm |
| 46 | lever arm | 48 | pin |
| 50 | strings | 52 | rim |
| 54 | mounting bracket | 56 | fastener bracket |
| 58 | fastener | 60 | string |
| 62 | string | | |

### DESCRIPTION OF THE INVENTION

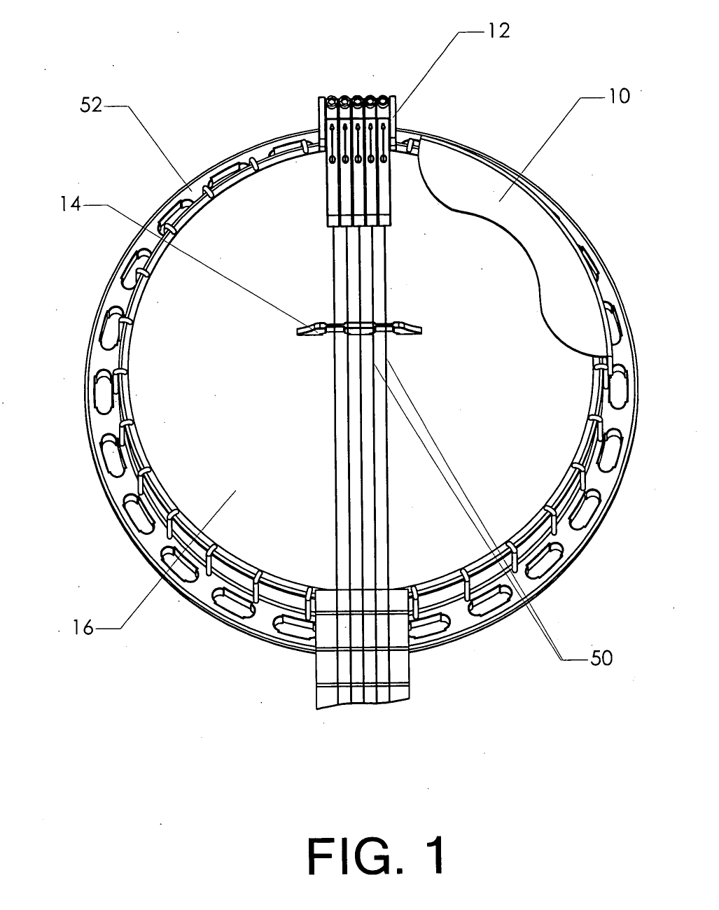

The present invention, tailpiece 12 is shown installed on banjo head 10 in FIG. 1. Skin 16 is attached to the top of banjo head 10 by rim 52. Strings 50 attach to tailpiece 12 and wrap over bridge 14 before extending up the fret board and attaching to the tuning screws (not shown). Tailpiece 12 rests on top of rim 52 so that the lever arms of tailpiece 12 extend over skin 16. Tailpiece 12 attaches to banjo head like conventional banjo tailpieces. Various attachment hardware is well known in the prior art.

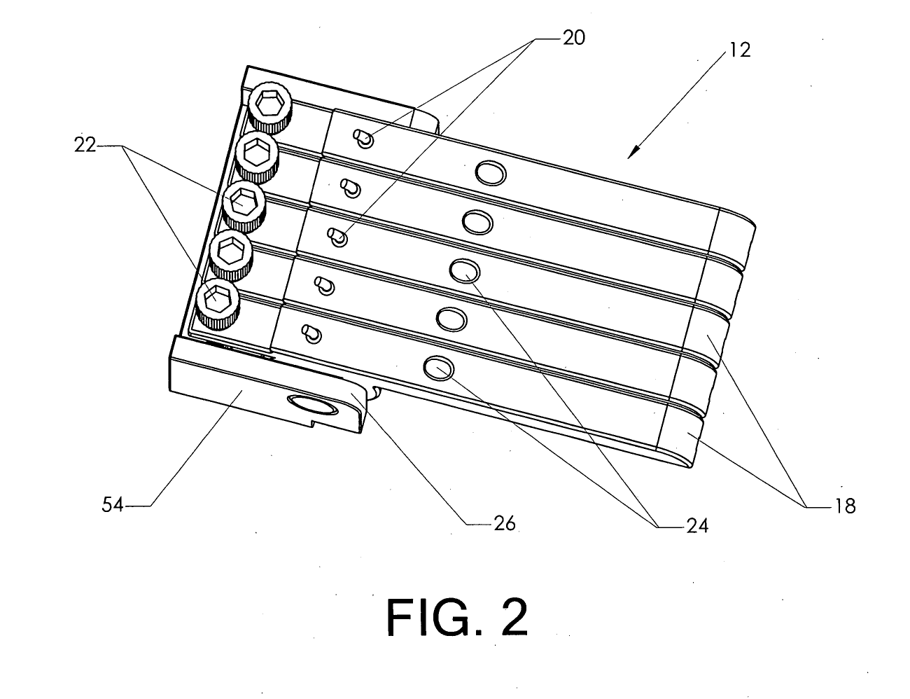

A detailed view of tailpiece 12 is provided in FIG. 2. Tailpiece 12 includes a plurality of lever arms 18 which are pivotally attached to mounting bracket 54. Although tailpiece 12 is shown with five lever arms 18, tailpiece 12 may also be provided with four lever arms for four string banjo applications. Mounting bracket 54 has a pair of support members 26 which provide lateral support to lever arms 18. Support members 26 prevent lever arms 18 from vibrating laterally when the banjo is played. Support members 26 also provide mounting points for a pin used to connect lever arms 18 to mounting bracket 54.

The strings are attached to lever arms 18 by wrapping the loop at the end of the banjo string around anchor pin 20 and inserting the banjo string through angled bore 24 from the top surface of lever arm 18 to the bottom surface of lever arm 18. The banjo string is then wrapped over the top of bridge 16 as shown in FIG. 1 and attached to the tuning screws. Screws 22 for adjusting the string angle of the banjo strings are also provided near one end of each of lever arms 18. The reader will note that screws 22 protrude upward from the top surfaces of lever arms 18 and are substantially perpendicular to the banjo strings. This feature facilitates on the fly string angle tuning. For example, if the user is playing the instrument and does not like the instruments intonation when a string is played, the user can quickly adjust the string angle without repositioning the instrument. The user simply identifies which lever arm corresponds to the string that needs adjustment, turns the screw to increase or decrease the string angle, plays the string again, and repeats the process until the desired intonation is achieved. Because screws 22 are in the user's line of sight when the instrument is in the playing position, the user does not have to flip the instrument so that the tail faces upward to make the string angle adjustments.

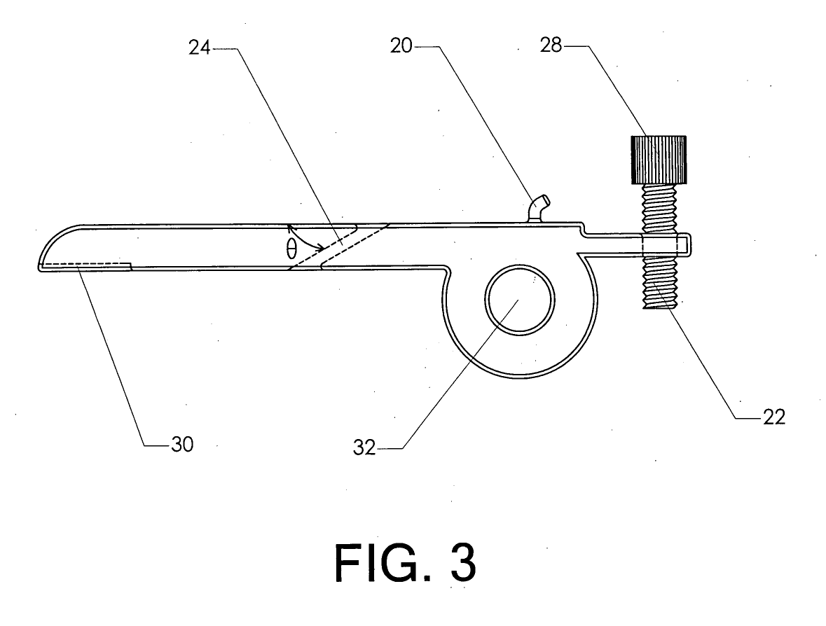

A detailed view of lever arm 18 is provided in FIG. 3. Angled bore 24 is angled with respect to the top surface of lever arm 18 by angle θ. Angle θ is preferably between 20 degrees and 70 degrees to prevent damage to the string caused by bending. Angle θ is even more preferably between 20 degrees and 50 degrees with a most preferred angle of approximately 30 degrees.

Lever arm 18 also includes groove 30 on the end of lever arm 18 opposite screw 22. Groove 30 is wide enough to receive the banjo string. Groove 30 prevents the banjo string from sliding off of the end of lever arm 18 when the string is played. Lever arm 18 further includes pivot bore 32 which receives the pin used to mount lever arm 18 to mounting bracket 54. A threaded bore is provided on the end of lever arm 18 opposite groove 30 for receiving screw 22. Screw 22 preferably includes knurled head 28 so that it may easily be turned by the user without the assistance of any tools. The head of screw 22 may also have a hexagonal keyway on top for use with a hexagonal key. The head may also be prepared for use with other tools.

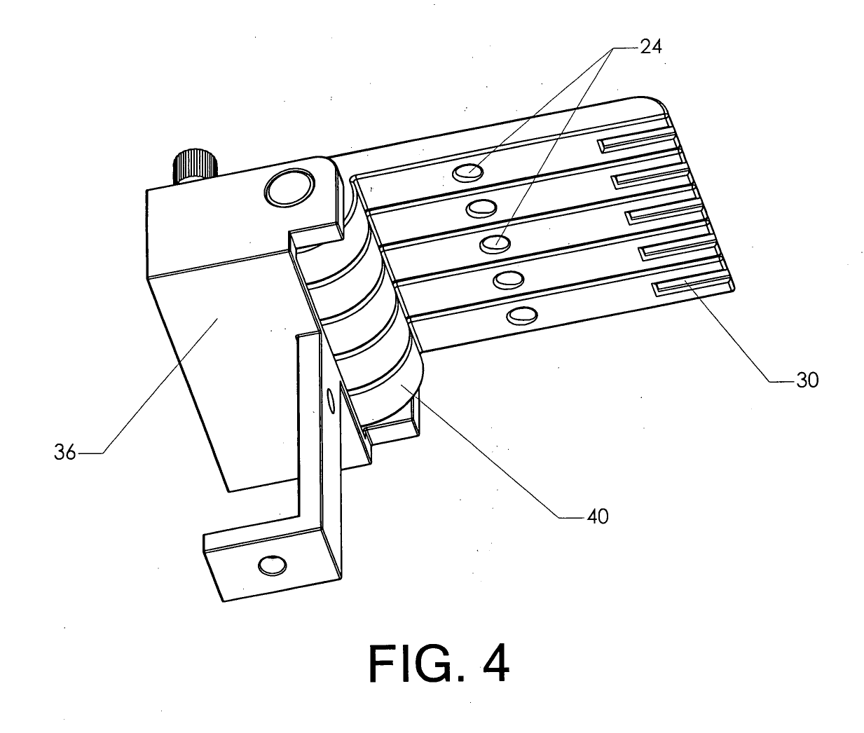

Tailpiece 12 is shown from another perspective in FIG. 4. The reader will appreciate that grooves 30 are provided along a portion of the length of the bottom surface of lever arms 18. Bearing plate 36 runs across the bottom of mounting bracket 54 between support members 26. Each of the lever arms attaches to mounting bracket 54 by pivot joint 40.

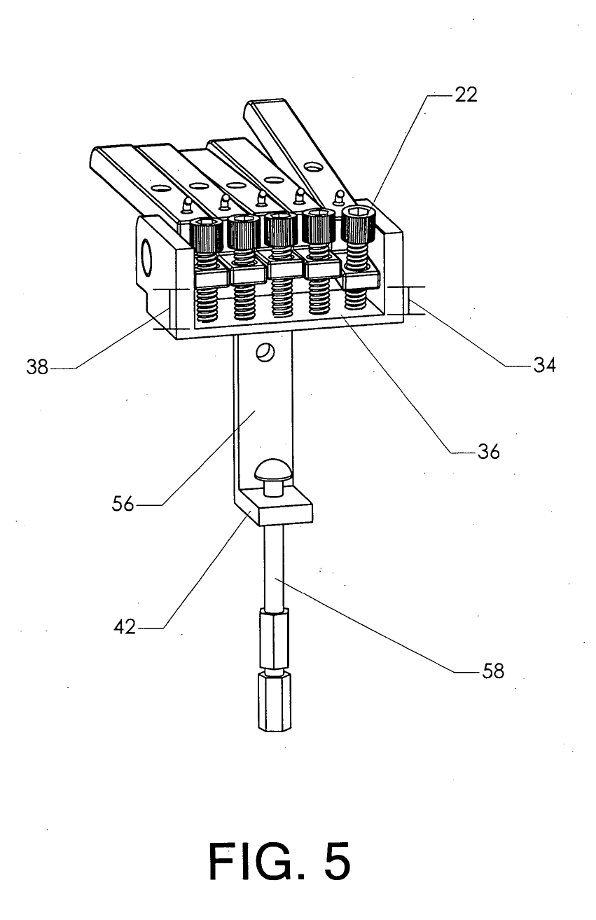

Yet another view of tailpiece 12 is provided in FIG. 5. From this perspective, the reader will appreciate how screws 22 can be used to set the desired amount of standoff of the lever arm with respect to bearing plate 36. From the perspective shown in FIG. 5, screw 22 on the right side of the tailpiece has shorter standoff 34 than screw 22 on the left side of the tailpiece. Taller standoff 38 is created by rotating the screw relative to the lever arm.

Attachment means 42 is one hardware configuration that may be used to attach the tailpiece to a banjo head. Attachment means 42 generally includes fastener bracket 56 and fastener 58. Fastener 58 may be formed by a screw and lug, as illustrated in FIG. 5, or fastener 58 may also be made with different hardware.

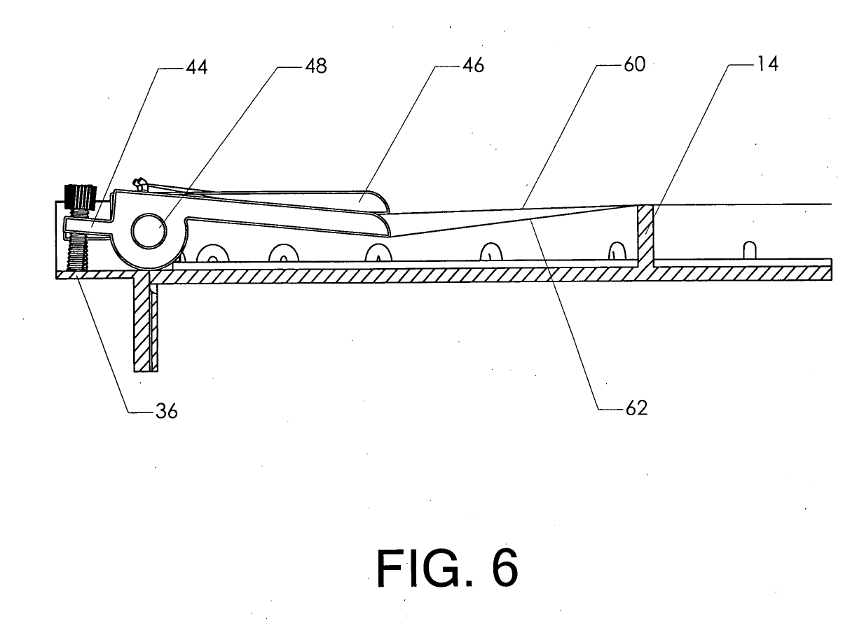

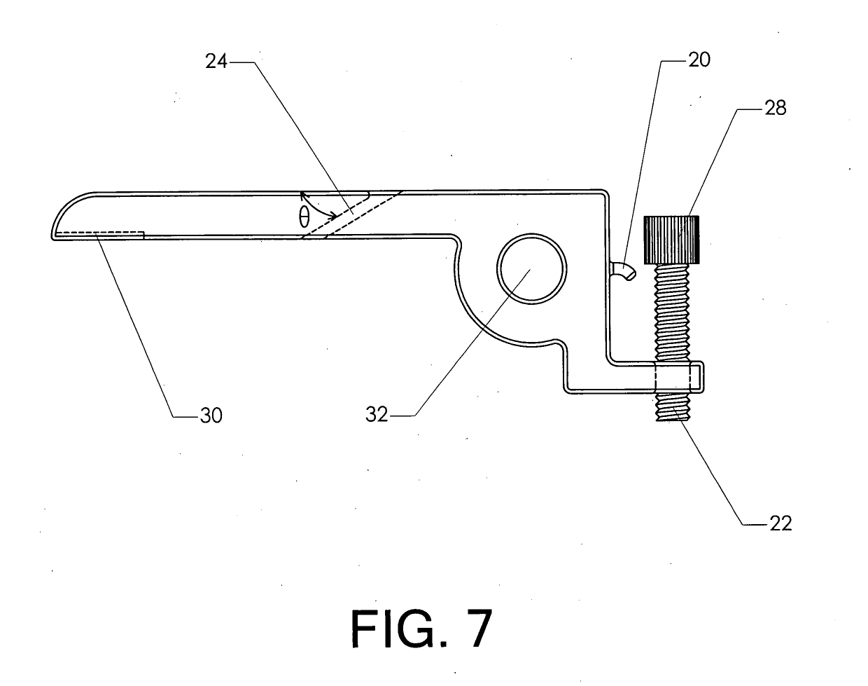

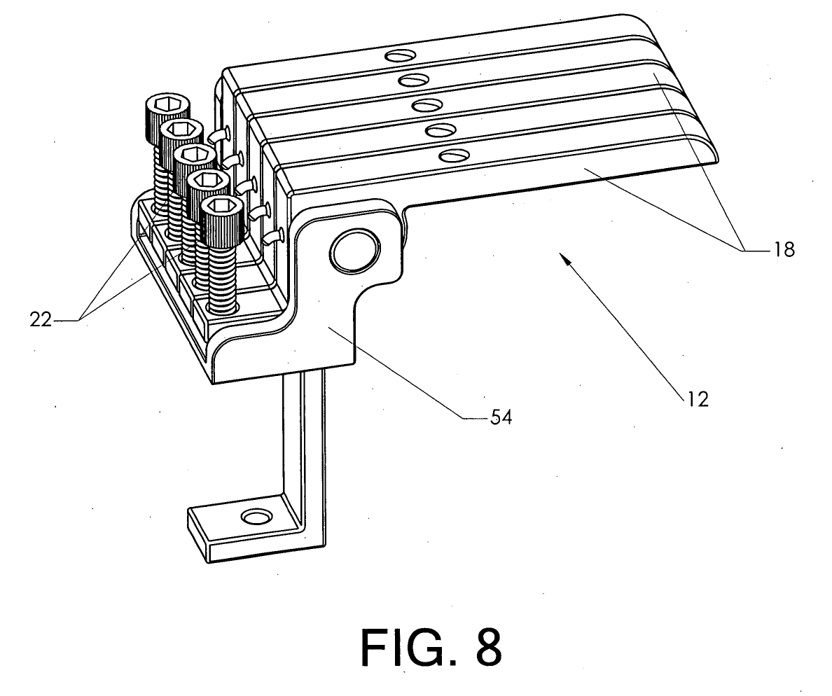

FIG. 6 is a section view of the tailpiece installed on a banjo head to illustrate how the tailpiece can be used to independently vary the string angle of each of the banjo strings. Lever arm 46, shown in the background, illustrates the effect of small standoff. When such small standoff is used, lever arm 46 causes string 60 to have only a minimal string angle with respect to skin 16. Lever arm 44, shown in the foreground, illustrates the effect of a larger standoff. When screw 22 is turned, lever arm 44 pivots about pin 48 causing the other end of lever arm 44 to press string 62 down closer to skin 16. Accordingly, a larger standoff between the lever arm and bearing plate 36 results in a larger string angle with respect to skin 16.

The preceding description contains significant detail regarding the novel aspects of the present invention. It should not be construed, however, as limiting the scope of the invention but rather as providing illustrations of the preferred embodiments of the invention. As an example, lever arms 18 can be made in many different shapes. FIGS. 7 and 8 show another design for lever arm 18. In this embodiment, the end of the lever arm near screw 22 has a different elevation than the end of the lever arm near groove 30. This configuration gives the lever arm a step-like appearance. FIG. 8 shows mounting bracket 54 which is adapted to fit the shape of the lever arm shown in FIG. 7. The reader will appreciate that although step-like lever arms 18 have a different shape than the lever arms illustrated in FIGS. 1-6, they function exactly the same.

In addition, the pivot joint could be placed above lever arms 18 relative to bearing plate 36 instead of being located between lever arms 18 and bearing plate 36. Such variations would not alter the function of the invention. Thus, the scope of the invention should be fixed by the following claims, rather than by the examples given.

Having described my invention, I claim:

1. A tailpiece for a banjo, said banjo having a head, a skin attached to said head, a plurality of strings, a bridge positioned between said skin and said plurality of strings, said bridge dividing each of said plurality of strings into a first length and a second length, said first length proximate said tailpiece and said second length distal said tailpiece, said first length of each of said plurality of strings having a string angle with respect to said skin, said tailpiece comprising:
a. a mounting bracket including
i. a bearing plate;
ii. an attachment means for attaching said tailpiece to said banjo;
b. a plurality of lever arms, each of said plurality of lever arms corresponding to one of said plurality of strings, each of said plurality of lever arms having
i. a first end, a second end, a medial section therebetween, a first surface proximate said head of said banjo, and a second surface distal said head of said banjo;
ii. a bore in said medial section of said lever arm passing through said lever arm from said first surface to said second surface, said bore wide enough to permit a banjo string to pass therethrough;
iii. a groove along said first surface proximate said first end of said lever arm; and
c. wherein each of said plurality of lever arms is connected to said mounting bracket by a pivot joint, said pivot joint positioned between said first end and said second end of said lever arm.

2. The tailpiece of claim 1, said mounting bracket further comprising a first support member, and a second support member, said first support member and said second support member together configured to provide lateral support to said plurality of lever arms.

3. The tailpiece of claim 1, further comprising a plurality of screws, each of said plurality of screws corresponding to one of said plurality of lever arms, wherein each of said plurality of screws are positioned between said second end of said lever arm and said pivot joint, and wherein each of said plurality of screws are configured to adjust said string angle of said corresponding string.

4. The tailpiece of claim 3, wherein each of said plurality of screws are arranged in a substantially perpendicular orientation with respect to said second length of said plurality of strings.

5. The tailpiece of claim 1, wherein said bore has a bore angle with respect to said second surface of said lever arm between 20 degrees and 70 degrees.

6. The tailpiece of claim 5, wherein said bore angle is between 20 degrees and 50 degrees.

7. The tailpiece of claim 6, wherein said bore angle is approximately 30 degrees.

8. The tailpiece of claim 1, each of said plurality of lever arms further comprising an anchor pin protruding from said second surface.

9. The tailpiece of claim 3, each of said plurality of lever arms further comprising an anchor pin protruding from said second surface, wherein said anchor pin is positioned between said screw and said bore.

10. The tailpiece of claim 3, wherein one of said plurality of screws is configured to adjust the standoff between said second end of said lever arm corresponding to said screw relative to said bearing plate.

11. The tailpiece of claim 1, wherein each of said plurality of levers are independently adjustable.
